(19) United States
(12) Patent Application Publication
(10) Pub. No.: US 2009/0046904 A1
(43) Pub. Date: Feb. 19, 2009

(54) FINGERPRINT RECOGNITION APPARATUS AND METHOD

(75) Inventors: Dae-Sung Moon, Daejeon (KR); Sung-Bum Pan, Daejeon (KR); Seung-Hoon Chae, Jeollanam-do (KR); Ki-Young Moon, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/143,297

(22) Filed: Jun. 20, 2008

(30) Foreign Application Priority Data
Aug. 13, 2007 (KR) 10-2007-0081210

(51) Int. Cl. G06K 9/00

(52) U.S. Cl. 382/124

(57) ABSTRACT

Provided are a fingerprint recognition apparatus and method which are capable of protecting registered fingerprint data and recognizing a fingerprint more quickly and accurately. In the fingerprint recognition apparatus, a fingerprint image generator generates fingerprint image data of an input fingerprint, and a memory stores registration fingerprint data for authentication. In a registration mode, a fingerprint recognition processor transforms the fingerprint image data into the irreversible registration fingerprint data using a specific transformation scheme, and stores the transformed registration fingerprint data. In an authentication mode, the fingerprint recognition processor transforms the fingerprint image data into comparison fingerprint data using the specific transformation scheme, compares whether the comparison fingerprint data is identical to the registration fingerprint data, and controls the authentication process according to the comparison result.

### CROSS-REFERENCE TO RELATED APPLICATIONS

This application claims priority under 35 U.S.C. §119 to Korean Patent Application No. 10-2007-0081210, filed on Aug. 13, 2007, the disclosure of which is incorporated herein by reference in its entirety.

### BACKGROUND OF THE INVENTION

1. Field of the Invention

The present disclosure relates to a fingerprint recognition apparatus, and more particularly, to a fingerprint recognition apparatus and method which are capable of protecting registered fingerprint data and recognizing a fingerprint more quickly and accurately.

This work was supported by the IT R&D program of MIC/IITA.

[2007-S-020-01, Development of Privacy Enhanced Biometric System]

2. Description of the Related Art

Generally, fingerprint is made by the elevation of sweat glands in regular patterns. Every person has a unique fingerprint, the shape of which is not changed for all his life. This knowledge was proved long ago and has been applied in real life. It is evaluated that a fingerprint recognition method has higher recognition reliability and stability because of the characteristics of the fingerprint, compared with an iris recognition method, a voice recognition method, or a face recognition method. Thus, the fingerprint recognition method is considered as the most efficient personal identification method. Persons' fingerprint data acquired are used as personal identity verification, for example, resident registration cards. Furthermore, the persons' fingerprint data are widely applied to criminal investigations. Moreover, new technologies for security systems and surveillance systems using biometrics including the fingerprint recognition have been recently proposed and usefully applied to a variety of fields.

Fingerprint recognition methods may be classified into image-based fingerprint recognition methods and feature-based fingerprint recognition methods.

The image-based fingerprint recognition method uses ridge information. The image-based fingerprint recognition method uses entire directional information of a fingerprint image by applying Gaber filter, fast Fourier transform (FFT), slope, directional histogram, projection, and the like.

The feature-based fingerprint recognition method generally includes a minutiae extraction process and a matching process. The feature-based fingerprint recognition method uses spatial characteristics of feature points extracted by applying a variety of image processing techniques, such as smoothing, separation of foreground and background, binarization, and thinning.

However, fingerprint recognition apparatuses using the relate art fingerprint recognition methods previously register input fingerprint data as registration fingerprint data without modification, and perform an authentication process to compare the registration fingerprint data with other person's fingerprint data input in an authentication mode. Therefore, these fingerprint recognition apparatuses are vulnerable to the leakage of registration fingerprint data. Furthermore, personal confidential information may be exposed to others by the leakage of the registration fingerprint data. Moreover, since the fingerprint data to be compared with the actual registration fingerprint data have different phase angles, phase and angle differences must be accumulated and corrected, leading to increase in the quantity of data.

### SUMMARY

Therefore, an object of the present invention is to provide a fingerprint recognition apparatus and method which are capable of protecting registered fingerprint data by registering fingerprint data transformed using a transformation scheme which makes it impossible to restore the registered fingerprint data into original fingerprint data in a fingerprint registration mode.

Another object of the present invention is to provide a fingerprint recognition apparatus and method which are capable of achieving a rapid authentication process with high reliability, without correction of a fingerprint input in a fingerprint authentication mode, by registering fingerprint data transformed while rotating and moving a fingerprint image of a recognized fingerprint.

To achieve these and other advantages and in accordance with the purpose(s) of the present invention as embodied and broadly described herein, a fingerprint recognition apparatus for performing an authentication process according to a recognized fingerprint in accordance with an aspect of the present invention includes: a fingerprint image generator for generating fingerprint image data of an input fingerprint; a memory for storing registration fingerprint data for authentication; and a fingerprint recognition processor for transforming the fingerprint image data into the irreversible registration fingerprint data using a specific transformation scheme and storing the transformed registration fingerprint data in a registration mode, transforming the fingerprint image data into comparison fingerprint data using the specific transformation scheme in an authentication mode, comparing whether the comparison fingerprint data is identical to the registration fingerprint data, and controlling the authentication process according to the comparison result.

The memory may store a plurality of transformation image data as the registration fingerprint data, the plurality of transformation image data being generated by transforming the fingerprint image data using the specific transformation scheme while changing coordinates of the fingerprint image data.

In the registration mode, the fingerprint recognition processor may correct a plurality of transformation image data generated using the specific transformation scheme, considering an allowable movement range and an allowable rotation range in the input of the fingerprint, and register the registration fingerprint data.

In the authentication mode, the fingerprint recognition processor may primarily compare the similarity between the comparison fingerprint data and the registration fingerprint data, and perform a secondary comparison when it is determined from the primary comparison that there is no similarity between the comparison fingerprint data and the registration fingerprint data while moving the comparison fingerprint data left and right.

The fingerprint recognition processor may include: a data transforming unit for transforming the recognized fingerprint into the registration fingerprint data or the comparison fingerprint data using the specific transformation scheme according to the mode; a fingerprint comparing unit for reading the registration fingerprint data from the memory and comparing whether the comparison fingerprint data is similar to the registration fingerprint data; and an authenticating unit for performing the authentication process according to the comparison result of the fingerprint comparing unit.

The specific transformation scheme may be a Log Polar Transform (LPT) for transforming the fingerprint image data of the recognized fingerprint into an image that is impossible to restore into an original image.

To achieve these and other advantages and in accordance with the purpose(s) of the present invention as embodied and broadly described herein, a fingerprint recognition method for performing an authentication process according to recognized fingerprint data in accordance with another aspect of the present invention includes: in a registration mode, recognizing an input fingerprint, transforming the recognized input fingerprint into irreversible registration fingerprint data using a specific transformation scheme, and registering the irreversible registration fingerprint data; and in an authentication mode, recognizing an input fingerprint, transforming the recognized input fingerprint into comparison fingerprint data using the specific transformation scheme, comparing a similarity between the comparison fingerprint data and the registration fingerprint data, and performing the authentication process according to the comparison result.

The registering of the irreversible registration fingerprint data may include adjusting the transformation image of the registration fingerprint data to an image size at which the image is impossible to restore into an original image.

To achieve these and other advantages and in accordance with the purpose(s) of the present invention as embodied and broadly described herein, a A fingerprint recognition method in accordance with another aspect of the present invention includes: acquiring fingerprint image data by imaging a recognized fingerprint; generating a plurality of transformation image data transformed using a specific transformation scheme while changing center coordinates of the fingerprint image data, and registering the plurality of transformation image data as registration fingerprint data; and comparing a similarity between the fingerprint image data of the recognized fingerprint and the registration fingerprint data in a fingerprint authentication mode, and performing an authentication process according to the comparison result.

The performing of the authentication process may include: acquiring the fingerprint image data by imaging the recognized fingerprint; transforming the acquired fingerprint image data into comparison fingerprint data using the specific transformation scheme at center coordinates thereof; and comparing a similarity between the comparison fingerprint data and the registration fingerprint data, and determining whether to authenticate the fingerprint according to the comparison result.

The determining of whether to authenticate the fingerprint may include: primarily comparing the comparison fingerprint data with the registration fingerprint data; and secondarily comparing the comparison fingerprint data with the registration fingerprint data while moving the comparison fingerprint data left and right, when it is determined from the primary comparison that there is no similarity between the comparison fingerprint data and the registration fingerprint data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a fingerprint recognition apparatus according to an embodiment of the present invention;

FIG. 2 is a block diagram of a fingerprint recognition processor illustrated in FIG. 1;

FIGS. 3A through 3E are photographs illustrating a fingerprint recognition method according to an embodiment of the present invention; and

FIGS. 4A through 4C are flowcharts illustrating a fingerprint recognition method according to an embodiment of the present invention.

### DETAILED DESCRIPTION OF EMBODIMENTS

According to a fingerprint recognition apparatus and method of the present invention, a fingerprint image data is acquired by recognizing a fingerprint to be registered, and the fingerprint data is protected by transforming the acquired fingerprint image data using a specific transformation scheme, which makes an image restoration impossible. Furthermore, the fingerprint image data is transformed into a plurality of transformed images while changing center coordinates of the fingerprint image data and rotating and moving the fingerprint image data, and the plurality of transformed images are registered as the registration fingerprint data, whereby a correction process is unnecessary in a fingerprint authentication mode. Therefore, the fingerprint recognition apparatus and method can increase the authentication speed and reliability.

Hereinafter, specific embodiments will be described in detail with reference to the accompanying drawings. The following description will be made focusing on parts necessary to understand the operations and effects of the present invention.

While specific embodiments of the fingerprint recognition apparatus and method are particularly shown and described for more fully understanding of the present invention, it will be apparent to those skilled in the art that various changes and modifications may be made without details.

Throughout the specification, a specific transformation scheme will be used to refer to an irreversible image transformation scheme that makes it impossible to restore a transformed image into an original image.

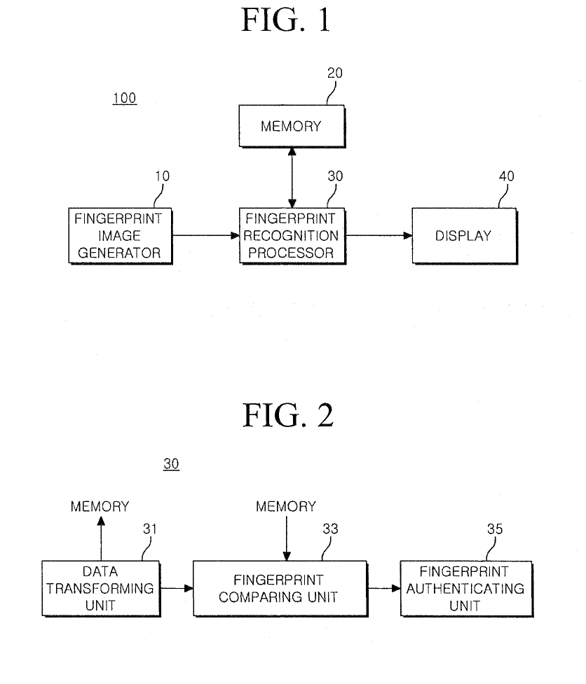

FIG. 1 is a block diagram of a fingerprint recognition apparatus according to an embodiment of the present invention.

Referring to FIG. 1, the fingerprint recognition apparatus 100 includes a fingerprint image generator 10, a memory 20, a fingerprint recognition processor 30, and a display 40.

The fingerprint image generator 10 generates fingerprint image data of an input fingerprint in a registration mode and an authentication mode.

The memory 20 stores registration fingerprint data that is registered in the registration mode.

The fingerprint recognition processor 30 controls an overall operation of the fingerprint recognition apparatus 100. In the registration mode, the fingerprint recognition processor 30 transforms the recognized fingerprint into irreversible registration fingerprint data using a specific transformation scheme, and stores the registration fingerprint data in the memory 20. In the authentication mode, the fingerprint recognition processor 30 transforms the recognized fingerprint into comparison fingerprint data using the specific transformation scheme. Then, the fingerprint recognition processor 30 compares the comparison fingerprint data with the registration fingerprint data to determine whether the comparison fingerprint data is similar to the registration fingerprint data, and performs an authentication process according to the comparison result.

More specifically, in the recognition mode, the fingerprint recognition processor 30 generates a plurality of transformation data using the specific transformation scheme, while changing center coordinates of the fingerprint image data generated by the fingerprint image generator 10 on a pixel basis and rotating and moving the fingerprint image data, and registers the transformation data as the registration fingerprint data.

In the authentication mode, the fingerprint recognition processor 30 transforms the fingerprint image data of the input fingerprint into the comparison fingerprint data using the specific transformation scheme, compares the comparison fingerprint data with the registration fingerprint data, and performs the authentication process according to the comparison result.

Since a position or angle of the image acquired in the authentication mode is different from that of the image acquired in the registration mode, a correction process is subsequently performed in the authentication process, causing a delay of an authentication speed. However, according to the embodiment of the present invention, a plurality of transformation images generated while changing the center coordinates are prepared in the registration mode. Therefore, a correction process is unnecessary in the authentication mode, and a more reliable authentication can be achieved.

An internal structure of the fingerprint recognition processor 30 will be described below in detail with reference to FIG. 2.

The display 40 displays messages generated during the execution of programs under the control of the fingerprint recognition processor 30. The display 40 displays screen data according to the registration mode and the authentication mode. In addition, the display 40 may include an LCD controller, a memory for storing image data, and an LCD panel.

FIG. 2 is a block diagram of the fingerprint recognition processor illustrated in FIG. 1.

Referring to FIG. 2, the fingerprint recognition processor 30 includes a data transforming unit 31, a fingerprint comparing unit 33, and a fingerprint authenticating unit 35.

The data transforming unit 31 transforms the recognized fingerprint into comparison fingerprint data using the specific transformation scheme in the registration mode and the authentication mode. Particularly, in the registration mode, the data transforming unit 31 generates a plurality of transformation images by transforming a plurality of fingerprint image data using the specific transformation scheme while changing the center coordinates of the acquired fingerprint image data and rotating the acquired fingerprint image data. Then, the data transforming unit 31 registers the transformation data as the registration fingerprint data.

Preferably, the registration fingerprint data is created with N transformation images that are generated by transforming the fingerprint image data using the specific transformation scheme while moving it on one-pixel basis. However, it is apparent to those skilled in the art that the registration fingerprint data can be created with M (<N) transformation images that are generated by transforming the fingerprint image data while moving it on more-than-two-pixel basis. Furthermore, the transformation images can be acquired while moving the fingerprint image data on an appropriate pixel basis, considering a tradeoff relationship between a recognition rate and an operation speed.

Meanwhile, the transformation images can be acquired while rotating the fingerprint image data on predetermined angle basis and then added to the registration fingerprint data.

When a Log-Polar Transform (LPT) is adopted as the specific transformation scheme, only left and right movements occur in the transformation images if the rotation images are LPT-processed. Therefore, in the registration mode, the rotation images need not be transformed.

That is, the registration fingerprint data can be created while changing only the center coordinates according to the kinds of transformation schemes. In this case, even though the rotation images are not transformed, the registration fingerprint data can be preferably created by performing the correction process using correction values of all possible cases within allowable rotation and movement ranges of a fingerprint authentication system in order not to perform the correction process in the fingerprint authentication mode.

In the authentication mode, the data transforming unit 31 acquires the fingerprint image data by imaging the recognized fingerprint, and transforms fingerprint image data into the comparison fingerprint data using the specific transformation scheme on the center coordinates of the acquired fingerprint image data. The data transforming unit 31 outputs the registration fingerprint data acquired in the registration mode to the memory 20, and outputs the comparison fingerprint data acquired in the authentication mode to the fingerprint comparing unit 33. It is preferable that the registration fingerprint data is registered with a predetermined image size at which the registered fingerprint data cannot be restored by inverse transformation of the registration fingerprint data previously registered, which will be described later.

The fingerprint comparing unit 33 reads the registration fingerprint data from the memory 20, primarily compares whether the comparison fingerprint data is similar to the registration fingerprint data, and outputs the comparison result. When it is determined from the primary comparison that there is no similarity between the comparison fingerprint data and the registration fingerprint data, the comparison fingerprint data is secondarily compared with the registration fingerprint data, while moving the comparison fingerprint data left and right.

That is, even the same person's fingerprint may have different angle or position of the fingerprint image data according to the direction or position of the finger in the registration mode and the authentication mode. When the registration fingerprint data is created considering the above-described situations, the user's finger may be located at an angle unexpected by the fingerprint authentication system in the authentication mode even though the registration fingerprint data is registered after correction using the correction values in all possible cases within the allowable rotation and movement ranges of the fingerprint authentication system. In addition, in the registration mode, the registration fingerprint data may be created without correction with respect to the possible rotation and movement ranges. For these reasons, it is preferable to perform the secondary comparison process for the rotation related correction. However, as described above, when the LPT is adopted as the transformation scheme, the rotation related correction can be easily performed while moving the transformation images left and right. Thus, there is no great difference in the processing speed of the authentication mode.

The fingerprint authenticating unit 35 performs the fingerprint authentication process according to the comparison result of the fingerprint comparing unit 33. The fingerprint authenticating unit 35 performs the fingerprint authentication process and transmits screen data to the display 40 to display the success or failure of the authentication. In addition, the fingerprint recognition apparatus 100 may further include an audio signal processor (not shown) to output different notification sounds according to the success or failure of the authentication.

An operation of the fingerprint recognition apparatus for recognizing the fingerprint and performing the authentication process will be described below with reference to FIGS. 1 and 2.

In the registration mode, the data transforming unit 31 generates a plurality of transformation image data while changing the center coordinates of the fingerprint image data generated by the fingerprint image generator 10. The data transforming unit 31 corrects the generated fingerprint image data, considering the allowable movement and rotation ranges, and registers the registration fingerprint data in the memory 30. This is done in order not to perform the correction process on the recognized fingerprint image data in the authentication mode. Therefore, the authentication mode can be performed quickly, and the fingerprint can be freely input, regardless of the input direction or position of the fingerprint in the authentication mode.

In the authentication mode, the data transforming unit 31 acquires the fingerprint image data by imaging the recognized fingerprint. The comparison fingerprint data is generated by the specific transformation scheme at the center coordinates of the acquired fingerprint image data. Thereafter, the fingerprint comparing unit 33 reads the registration fingerprint data from the memory 20, and compares the similarity between the comparison fingerprint data and the registration fingerprint data. After comparing the similarity of the fingerprint data, the fingerprint comparing unit 33 outputs the comparison result to the fingerprint authenticating unit 35. When the comparison fingerprint data is similar to the registration fingerprint data, the fingerprint authenticating unit 35 notifies the success or failure of the authentication to the user, who inputs the fingerprint in the authentication mode, through the display 40, and authorizes the user to use the functions of the system including the fingerprint recognition apparatus 100. On the other hand, when the comparison fingerprint data is not similar to the registration fingerprint data, the fingerprint authenticating unit 35 notifies the failure of the authentication to the user, who inputs the fingerprint in the authentication mode, through the display 40. In this case, the user is not authorized to use the functions of the system including the fingerprint recognition apparatus 100.

The registration mode and the authentication mode using the specific transformation scheme in the fingerprint recognition apparatus 100 will be described below in more detail.

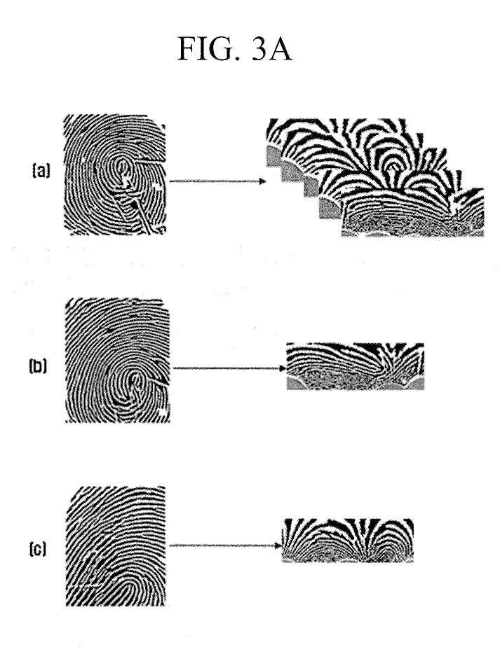

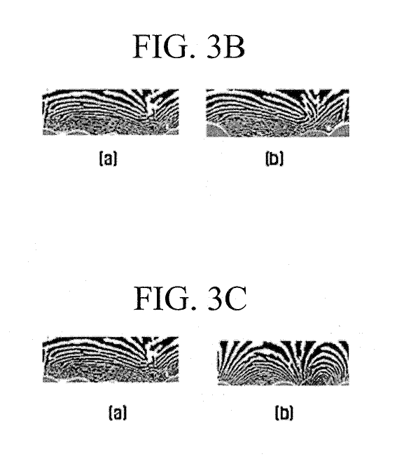

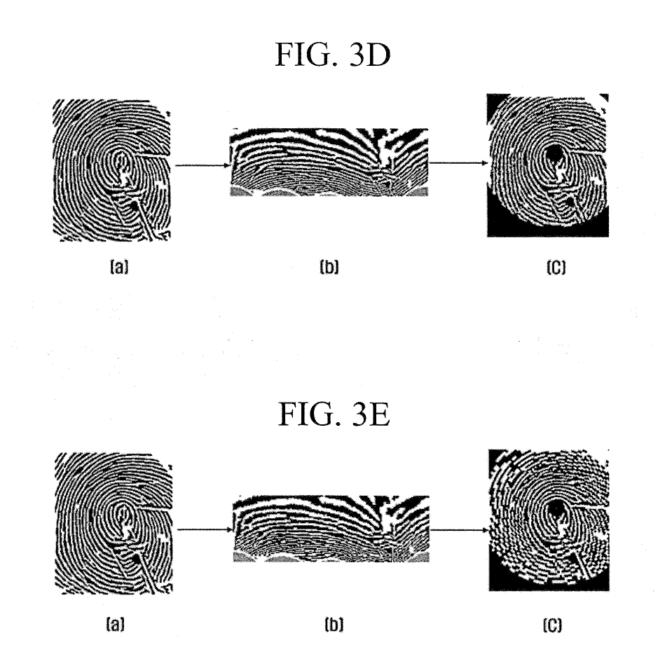

FIGS. 3A through 3E are photographs illustrating a fingerprint recognition method according to an embodiment of the present invention, where an LPT is adopted as a specific transformation scheme.

The registration fingerprint data registered in the registration mode is illustrated in FIG. 3A(a), and the comparison fingerprint data acquired in the authentication mode is illustrated in FIGS. 3A(a), 3A(b) and 3A(c).

As illustrated in FIG. 3A(a), the fingerprint recognition processor 30 generates a plurality of transformation images using the specific transformation scheme while changing the center coordinates of the fingerprint image data. The translation images are registered as the registration fingerprint data.

Thereafter, as illustrated in FIGS. 3A(b) and 3A(c), the authentication mode is enabled to generate the comparison fingerprint data using the specific transformation scheme at the center coordinates of the fingerprint image data. The fingerprint recognition processor 30 measures the similarity between the comparison fingerprint data of FIGS. 3A(b) and 3A(c) and the registration fingerprint data of FIG. 3A(a) by comparing the comparison fingerprint data and the registration fingerprint data.

The similarity between the comparison fingerprint data of FIGS. 3A(b) and 3A(c) and one of the plurality of fingerprint image data registered in FIG. 3A(a) is compared and analyzed.

As the comparison result, it can be seen from FIG. 3B that the fingerprint data of FIG. 3A(b) is similar to the fingerprint data of FIG. 3A(a). That is, the two fingerprints are determined as the same person's fingerprints.

On the other hand, it can be seen from FIG. 3C that the fingerprint data of FIG. 3A(c) is different from the fingerprint data of FIG. 3A(a). That is, the two fingerprints are determined as the different persons' fingerprints. FIGS. 3B(a) and 3C(a) illustrate a fingerprint image data selected from the plurality of fingerprint image data of FIG. 3A(a), and FIG. 3B(b) illustrates the comparison fingerprint data of FIG. 3A(b). FIG. 3C(b) illustrates the comparison fingerprint data of FIG. 3A(c).

Meanwhile, it is preferable that the registration fingerprint data should not be restored to the original fingerprint data, even through the inverse transformation, by transforming the registration fingerprint data using the specific transformation scheme.

It can be seen from FIGS. 3D and 3E that, when the LPT is adopted as the specific transformation scheme, the transformation images are not restored to the original fingerprint data, even through the inverse transformation of the transformation images.

For example, assuming that the fingerprint image data of FIG. 3D(a) is transformed using the specific transformation scheme and registered as the registration fingerprint data of FIG. 3D(b) with a size of 360×180, the fingerprint image data of FIG. 3D(c) is an image data acquired by inversely transforming the registration fingerprint data of FIG. 3D(b). In addition, assuming that the fingerprint image data of FIG. 3E(a) is transformed using the specific transformation scheme and registered as the registration fingerprint data of FIG. 3E(b) with a size of 180×62, the fingerprint image data of FIG. 3E(c) is an image data acquired by inversely transforming the registration fingerprint data of FIG. 3E(b). Thus, it can be seen that it is difficult to restore the registration fingerprint data, which has been transformed using the specific transformation scheme, to the original fingerprint image data through the inverse transformation of the specific transformation scheme. In addition, it can be seen that it is more difficult to restore the registration fingerprint data with the size of 180×62 to the original fingerprint data than the registration fingerprint data with the size of 360×180. This is because the pixel data of the registration fingerprint image with the size of 180×62 is smaller than that of the registration fingerprint image with the size of 360×180. Therefore, it is preferable that the image size of the registration fingerprint data is so small that it cannot be restored through the inverse transformation of the specific transformation scheme.

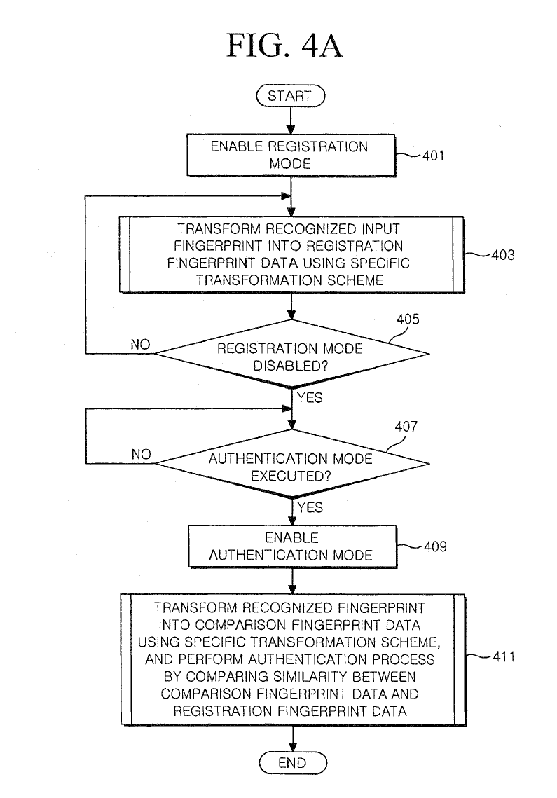

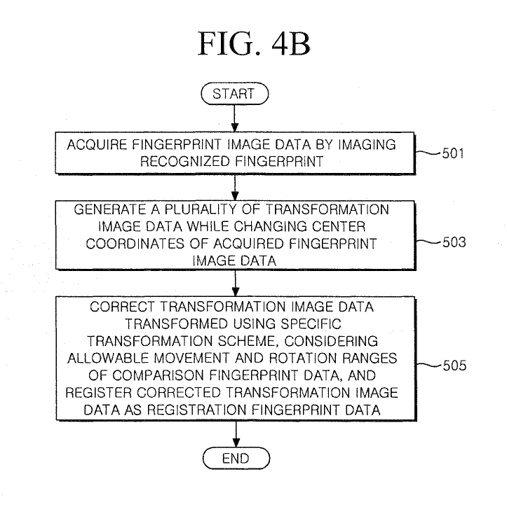

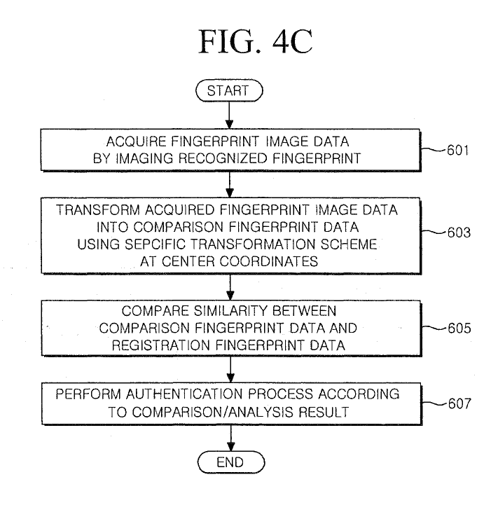

FIGS. 4A through 4C are flowcharts illustrating a fingerprint recognition method according to an embodiment of the present invention.

Referring to FIGS. 4A through 4C, the user previously registers his/her fingerprint for reasons of security of the system with the fingerprint recognition apparatus 100. In operation 401, the fingerprint recognition processor 30 enables the registration mode according to a user's request for executing the registration mode.

In operation 403, the fingerprint recognition processor 30 acquires fingerprint data by recognizing the input fingerprint, transforms the acquired fingerprint data into the registration fingerprint data using the specific transformation scheme, and registers the registration fingerprint data.

The registration of the registration fingerprint data in operation 403 will be described below in more detail.

In operation 501, the fingerprint recognition processor 30 acquires the fingerprint image data by imaging the recognized fingerprint.

In operation 503, the fingerprint recognition processor 30 generates a plurality of transformation image data while changing the center coordinates of the acquired fingerprint image data.

In operation 505, the fingerprint recognition processor 30 corrects the plurality of transformation image data transformed using the specific transformation scheme, considering the allowable movement and rotation ranges of the comparison fingerprint data, and registers the corrected transformation image data as the registration fingerprint data. This is done for enabling the input of the fingerprint at arbitrary angle and position in the authentication mode, without correction of the input comparison fingerprint data.

Then, the fingerprint recognition processor 30 proceeds to operation 405 to determine whether the registration mode is disabled.

When the registration mode is disabled in operation 405, the fingerprint recognition processor 30 proceeds to operation 407. On the other hand, when the registration mode is not disabled, the fingerprint recognition processor 30 returns to operation 403 to re-input the fingerprint and register the registration fingerprint data of the re-input fingerprint.

In operation 407, the fingerprint recognition processor 30 determines whether the authentication mode is executed. In the authentication mode, the user can input an authentication mode execution request key, or can input the fingerprint and request the execution of the authentication mode.

In operation 409, when the authentication mode is executed in 407, the fingerprint recognition processor 30 enables the authentication mode.

In operation 411, the fingerprint recognition processor 30 recognizes the input fingerprint, transforms the recognized fingerprint into the comparison fingerprint data by using the specific transformation scheme, compares the similarity between the comparison fingerprint data and the registration fingerprint data, and performs the authentication process according to the comparison result.

The authentication process in operation 411 will be described below in more detail.

In operation 601, the fingerprint recognition processor 30 acquires the fingerprint image data by imaging the recognized fingerprint.

In operation 603, the fingerprint recognition processor 30 transforms the acquired fingerprint image data into the comparison fingerprint data by using the specific transformation scheme at the center coordinates of the acquired fingerprint image data.

In operation S605, the fingerprint recognition processor 30 compares the similarity between the comparison fingerprint data and the registration fingerprint data.

When the comparison fingerprint data is similar to the registration fingerprint data, the fingerprint recognition processor 30 outputs the notification sound notifying the success of the authentication and displays the corresponding screen data.

On the other hand, when the comparison fingerprint data is not similar to the registration fingerprint data, the fingerprint recognition processor 30 outputs the notification sound notifying the failure of the authentication and displays the corresponding screen data.

As described above, the fingerprint image data of the registration fingerprint data is transformed such that it cannot be inversely transformed. That is, the registration fingerprint data is not restored to the original fingerprint image. Therefore, even when the registration table leaks out, the fingerprint images can be protected. Since the leakage and abuse of the fingerprint data can be prevented, the reliability of the security can be increased.

Furthermore, by registering the plurality of fingerprint image data as the registration fingerprint data while changing the center coordinates of the fingerprint image data, the authentication process can be performed without correcting the images of the fingerprint data input in the fingerprint authentication mode, thereby reducing the fingerprint authentication processing time.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A fingerprint recognition apparatus for performing an authentication process according to a recognized fingerprint, comprising:
a fingerprint image generator for generating fingerprint image data of an input fingerprint;
a memory for storing registration fingerprint data for authentication; and
a fingerprint recognition processor for transforming the fingerprint image data into the irreversible registration fingerprint data using a specific transformation scheme and storing the transformed registration fingerprint data in a registration mode, transforming the fingerprint image data into comparison fingerprint data using the specific transformation scheme in an authentication mode, comparing whether the comparison fingerprint data is identical to the registration fingerprint data, and controlling the authentication process according to the comparison result.

2. The fingerprint recognition apparatus of claim 1, wherein the memory stores a plurality of transformation image data as the registration fingerprint data, the plurality of transformation image data being generated by transforming the fingerprint image data using the specific transformation scheme while changing coordinates of the fingerprint image data.

3. The fingerprint recognition apparatus of claim 1, wherein, in the registration mode, the fingerprint recognition processor corrects a plurality of transformation image data generated using the specific transformation scheme, considering an allowable movement range and an allowable rotation range in the input of the fingerprint, and registers the registration fingerprint data.

4. The fingerprint recognition apparatus of claim 1, wherein, in the authentication mode, the fingerprint recognition processor primarily compares the similarity between the comparison fingerprint data and the registration fingerprint data, and performs a secondary comparison when it is determined from the primary comparison that there is no similarity between the comparison fingerprint data and the registration fingerprint data while moving the comparison fingerprint data left and right.

5. The fingerprint recognition apparatus of claim 1, wherein the fingerprint recognition processor comprises:
a data transforming unit for transforming the recognized fingerprint into the registration fingerprint data or the comparison fingerprint data using the specific transformation scheme according to the mode;
a fingerprint comparing unit for reading the registration fingerprint data from the memory and comparing whether the comparison fingerprint data is similar to the registration fingerprint data; and
an authenticating unit for performing the authentication process according to the comparison result of the fingerprint comparing unit.

6. The fingerprint recognition apparatus of claim 5, wherein, in the registration mode, the data transforming unit registers a plurality of transformation image data as the registration fingerprint data, the plurality of transformation image data being generated by transforming the fingerprint image data using the specific transformation scheme while changing coordinates of the fingerprint image data; and, in the authentication mode, the data transforming unit acquires fingerprint image data by imaging the recognized fingerprint, and transforms the acquired fingerprint image data into comparison fingerprint data using the specific transformation scheme.

7. The fingerprint recognition apparatus of claim 5, wherein the data transforming unit corrects a plurality of transformation image data transformed using the specific transformation scheme, considering an allowable movement range and an allowable rotation range of the comparison fingerprint data, and registers the corrected transformation image data as the registration fingerprint data.

8. The fingerprint recognition apparatus of claim 1, further comprising a display for displaying screen data notifying the success or failure of the authentication according to the authentication process.

9. The fingerprint recognition apparatus of claim 1, wherein the specific transformation scheme is a Log Polar Transform (LPT) for transforming the fingerprint image data of the recognized fingerprint into an image that is impossible to restore into an original image.

10. The fingerprint recognition apparatus of claim 1, wherein the registration fingerprint data is transformation image data having an image size at which the image is impossible to restore into an original image through an inverse transformation of the specific transformation scheme.

11. A fingerprint recognition method for performing an authentication process according to recognized fingerprint data, the method comprising:
in a registration mode, recognizing an input fingerprint, transforming the recognized input fingerprint into irreversible registration fingerprint data using a specific transformation scheme, and registering the irreversible registration fingerprint data; and
in an authentication mode, recognizing an input fingerprint, transforming the recognized input fingerprint into comparison fingerprint data using the specific transformation scheme, comparing a similarity between the comparison fingerprint data and the registration fingerprint data, and performing the authentication process according to the comparison result.

12. The fingerprint recognition method of claim 11, wherein the specific transformation scheme is a Log Polar Transform (LPT) for transforming the fingerprint image data of the recognized fingerprint into an image that is impossible to restore into an original image.

13. The fingerprint recognition method of claim 11, wherein the registering of the irreversible registration fingerprint data comprises adjusting the transformation image of the registration fingerprint data to an image size at which the image is impossible to restore into an original image.

14. A fingerprint recognition method, comprising:
acquiring fingerprint image data by imaging a recognized fingerprint;
generating a plurality of transformation image data transformed using a specific transformation scheme while changing center coordinates of the fingerprint image data, and registering the plurality of transformation image data as registration fingerprint data; and
comparing a similarity between the fingerprint image data of the recognized fingerprint and the registration fingerprint data in a fingerprint authentication mode, and performing an authentication process according to the comparison result.

15. The fingerprint recognition method of claim 14, wherein the registering of the plurality of transformation image data as the registration fingerprint data further comprises correcting the plurality of transformation image data transformed using the specific transformation scheme, considering an allowable movement range and an allowable rotation range of the input fingerprint according to a fingerprint recognition system.

16. The fingerprint recognition method of claim 14, wherein the performing of the authentication process comprises:
acquiring the fingerprint image data by imaging the recognized fingerprint;
transforming the acquired fingerprint image data into comparison fingerprint data using the specific transformation scheme at center coordinates thereof; and
comparing a similarity between the comparison fingerprint data and the registration fingerprint data, and determining whether to authenticate the fingerprint according to the comparison result.

17. The fingerprint recognition method of claim 16, wherein the determining of whether to authenticate the fingerprint comprises:
primarily comparing the comparison fingerprint data with the registration fingerprint data; and
secondarily comparing the comparison fingerprint data with the registration fingerprint data while moving the comparison fingerprint data left and right, when it is determined from the primary comparison that there is no similarity between the comparison fingerprint data and the registration fingerprint data.

18. The fingerprint recognition method of claim 14, wherein the performing of the authentication process comprises:
outputting a sound notifying a successful authentication and displaying a corresponding screen data when the comparison fingerprint data is similar to the registration fingerprint data; and
outputting a sound notifying a failed authentication and displaying a corresponding screen data when the comparison fingerprint data is not similar to the registration fingerprint data.
